(19) United States
(12) Patent Application Publication
(10) Pub. No.: US 2022/0326931 A1
(43) Pub. Date: Oct. 13, 2022

(54) SYSTEM AND METHOD FOR MANAGING UPDATE OF ELECTRONIC CONTROL UNIT OF VEHICLE

(71) Applicants: Hyundai Motor Company, Seoul (KR); Kia Corporation, Seoul (KR)

(72) Inventor: Byung Il Choi, Hwaseong (KR)

(21) Appl. No.: 17/398,576

(22) Filed: Aug. 10, 2021

(30) Foreign Application Priority Data
Apr. 8, 2021 (KR) 10-2021-0046144

(51) Int. Cl. G06F 8/65; G06F 11/14; B60W 50/06; B60W 50/14

(52) U.S. Cl. CPC G06F 8/65; G06F 11/1433; B60W 50/06; B60W 50/14; G06F 2201/82; B60W 2556/45

(57) ABSTRACT

A system and method for managing an update of an electronic control unit (ECU) of a vehicle are configured to provide an ECU update service to a vehicle to which an over the air (OTA) technology is not applied regardless of time. The system includes a first communication device that transmits a vehicle ECU update guide message to a user terminal, a second communication device that transmits an update file to the vehicle as the vehicle enters a short-range communication area, and a controller that manages updating of the ECU of the vehicle.

### CROSS-REFERENCE TO RELATED APPLICATION

This application claims under 35 U.S.C. § 119(a) the benefit of Korean Patent Application No. 10-2021-0046144, filed in the Korean Intellectual Property Office on Apr. 8, 2021, the entire contents of which are incorporated herein by reference.

### BACKGROUND

### (a) Technical Field

The present disclosure relates to a system and method for managing software updates of each electronic control unit (ECU) in a vehicle.

### (b) Description of the Related Art

As electronization of parts for a vehicle is a continuing trend, and the types and number of electronic devices mounted on the vehicle have increased. The electronic devices may be used in a power train control system, a body control system, a chassis control system, a vehicle network, a multimedia system, and the like. The power train control system may include an engine control system, an automatic shift control system, and the like. The body control system may include a body electronic part control system, a convenience device control system, a lamp control system, and the like. The chassis control system may include a steering device control system, a brake control system, a suspension control system, and the like. The vehicle network may include a controller area network (CAN), a FlexRay-based network, a media oriented system transport (MOST)-based network, and the like. The multimedia system may include a navigation device system, a telematics system, an infotainment system, and the like.

Such systems and electronic devices constituting each of the systems are connected to each other through a vehicle network, and a vehicle network for supporting a function of each of the electronic devices is required. The controller area network (CAN) may support a transmission speed of up to 1 Mbps, and may support automatic re-transmission of collided frames, error detection based on cycle redundancy check (CRC), and the like. The FlexRay-based network may support a transmission speed of up to 10 Mbps, and may support simultaneous transmission of data through two channels, data transmission in a synchronous manner, and the like. The MOST-based network, which is a communication network for high-quality multimedia, may support a maximum transmission speed of 150 Mbps.

In one example, the telematics system, the infotainment system, an improved safety system, and the like of the vehicle require a high transmission speed, system scalability, and the like, but the CAN, the FlexRay-based network, and the like are not able to fully support those requirements. The MOST-based network may support higher transmission speed than the CAN and the FlexRay-based network, but it is expensive to apply the MOST-based network to all networks of the vehicle. Because of such problems, an Ethernet-based network may be considered as the vehicle network. The Ethernet-based network may support bidirectional communication through a pair of windings, and may support a maximum transmission speed of 10 Gbps.

Each of the electronic devices connected to each other through the vehicle network as such has an ECU, and at least one type of software is installed in each ECU. Thus, the number of types of software installed in each ECU in the vehicle ranges from dozens to hundreds, so that there is a need for a method for managing updates therefor.

In general, a driver of a vehicle to which an over the air (OTA) technology (software wireless update) is not applied must visit a service center directly and receive help of an administrator (e.g., service technician) to update the ECU in the vehicle. That is, a conventional scheme for updating the ECU of the vehicle receives update data from an administrator terminal connected in a wired manner, and updates the software of the ECU based on the received update data. Such conventional scheme has a problem of lack of convenience in that the driver must bring his or her vehicle in for servicing, and any updates typically are not provided outside of working hours (e.g., weekends or holidays) when the administrator is not working because the help of the administrator is required.

The matters described in this background are written to enhance an understanding of the background of the invention, which may include matters other than the prior art already known to those of ordinary skill in the field to which this technology belongs.

### SUMMARY

An aspect of the present disclosure provides a system and a method for managing update of an electronic control unit (ECU) of a vehicle that have a cloud server that manages update of each ECU in the vehicle, and an edge server located in a predetermined zone and in communication with the cloud server, and transmit update data of the ECU to the vehicle in a short-range communication scheme, thereby providing an ECU update service to a vehicle to which an over the air (OTA) technology is not applied regardless of time.

The technical problems to be solved by the present inventive concept are not limited to the aforementioned problems, and any other technical problems not mentioned herein will be clearly understood from the following description by those skilled in the art to which the present disclosure pertains.

According to an aspect of the present disclosure, a device for managing update of an ECU of a vehicle includes a first communication device that transmits a vehicle ECU (Electronic Control Unit) update guide message to a user terminal, a second communication device that transmits an update file to the vehicle as the vehicle enters a short-range communication area, and a controller that manages updating of the ECU of the vehicle.

In one implementation, the controller may manage update history information for each user, and at least one of an updated ECU, an update date, an update time, or an update version may be recorded in the update history information.

In one implementation, the controller may notify that there is no ECU to be updated to the user terminal when there is no ECU to be updated in the vehicle that has entered the short-range communication area.

In one implementation, the controller may detect an error in a process of receiving the update file of each ECU for each vehicle model.

In one implementation, the controller may perform a roll back of returning a software version of the ECU to a software version prior to receiving the update file when an error occurs in the process of updating the ECU of the vehicle.

In one implementation, the controller may notify that there is an error in the update file to the user terminal.

In one implementation, the controller may adjust at least one of a transmission period or a transmission time of the guide message based on preset conditions.

According to another aspect of the present disclosure, a method for managing update of an ECU of a vehicle includes transmitting, by a first communication device, a vehicle ECU (Electronic Control Unit) update guide message to a user terminal, transmitting, by a second communication device, an update file to the vehicle as the vehicle enters a short-range communication area, and managing, by a controller, updating of the ECU of the vehicle.

In one implementation, the managing of updating of the ECU of the vehicle may include managing update history information, wherein at least one of an updated ECU, an update date, an update time, or an update version is recorded in the update history information.

In one implementation, the transmitting of the update file may further include notifying that there is no ECU to be updated to the user terminal when there is no ECU to be updated in the vehicle that has entered the short-range communication area.

In one implementation, the managing of updating of the ECU of the vehicle may include performing a roll back of returning a software version of the ECU to a software version prior to the update when an error occurs in the process of updating the ECU of the vehicle.

In one implementation, the managing of updating of the ECU of the vehicle may further include notifying that there is an error in the update file to the user terminal.

In one implementation, the transmitting of the update file may further include adjusting at least one of a transmission period or a transmission time of the guide message based on preset conditions.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram of an ECU update management system of a vehicle according to an embodiment of the present disclosure;

FIG. 2 is a block diagram of an ECU update management device of a vehicle according to an embodiment of the present disclosure;

FIG. 3 is a flowchart of a method for updating an ECU of a vehicle according to an embodiment of the present disclosure; and

FIG. 4 is a block diagram showing a computing system for executing a method for updating an ECU of a vehicle according to an embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unif”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of the related known configuration or function will be omitted when it is determined that it interferes with the understanding of the embodiment of the present disclosure.

In describing the components of the embodiment according to the present disclosure, terms such as first, second, A, B, (a), (b), and the like may be used. These terms are merely intended to distinguish the components from other components, and the terms do not limit the nature, order or sequence of the components. Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

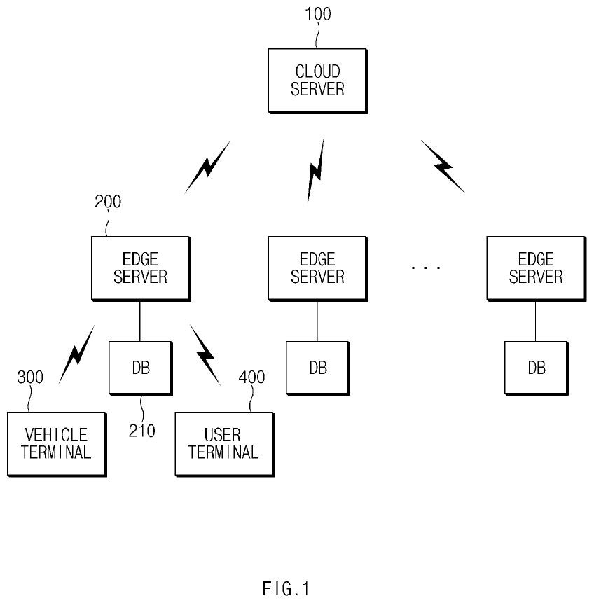

FIG. 1 is a block diagram of an ECU update management system of a vehicle according to an embodiment of the present disclosure.

As shown in FIG. 1, an ECU update management system of a vehicle according to an embodiment of the present disclosure may include a cloud server 100, an edge server 200, a database (DB) 210, a vehicle terminal 300, and a user terminal 400. In this connection, the edge server 200 may also be referred to as an ECU update management device of the vehicle.

Each of the components will be described. First, the cloud server 100 may communicate with the edge server 200, the vehicle terminal 300, and the user terminal 400. In this connection, the cloud server 100 may transmit an update file (i.e., a software update file) of each ECU for each vehicle model to the edge server 200 located in each zone, receive user information from the user terminal 400 to register a user, and store service conditions set by the user.

The cloud server 100 may include a database (DB) that stores the update file of each ECU for each vehicle model, a DB that accumulates and stores real-time location information of the vehicle received from the vehicle terminal 300, and a DB that stores information on various service conditions (e.g., whether to notify new update, a new update notification time, an update type, an update cycle, an update time, an update target, and the like) set by the user.

The cloud server 100 may recommend an update zone (or an optimal edge server) to the vehicle based on vehicle location history data.

The edge server 200, which is a server installed for each predetermined zone to perform edge computing, substantially manages update of each ECU in the vehicle. Therefore, the user must place the vehicle in the predetermined zone to receive the ECU update.

The edge server 200 may communicate with the cloud server 100, other edge servers, the vehicle terminal 300, and the user terminal 400. In this connection, the edge server 200 may perform short-range communication with the vehicle terminal 300 and the user terminal 400. In this connection, the short-range communication may include a Bluetooth™, a radio frequency identification (RFID), an infrared communication (infrared data association; IrDA), an ultra wideband (UWB), a ZigBee, a near field communication (NFC), a wireless universal serial bus (wireless USB), and the like. In addition, the edge server 200 may perform long-distance communication (mobile communication) with the vehicle terminal 300 and the user terminal 400. For example, the edge server 200 may transmit an ECU update guide message to the user terminal 400 through the mobile communication.

The edge server 200 may have the DB 210 that stores communication history information in which a date and a time at which communication with cloud server 100 has occurred, and a name and the like of transmitted/received data are recorded, information on a vehicle model owned by each customer, update history information in which a type of an updated ECU for each customer, an update date, an update time, an update version, and the like are recorded, and an update file of each ECU for each vehicle model received from the cloud server 100. In this connection, the edge server 200 may share the update history information with other edge servers.

The edge server 200 may detect various errors (packet loss, hacking, and the like) occurring in a process of receiving the update file of each ECU for each vehicle model from the cloud server 100, and compare the update file of each ECU for each vehicle model stored in the cloud server 100 with the update file of each ECU for each vehicle model stored in the DB 210 to monitor whether the latest update file of each ECU for each vehicle model is stored in the DB 210.

When an error occurs in the process of updating the ECU of the vehicle, the edge server 200 may notify the user terminal 400 that there is the error in the update file, perform roll back that returns a software version of the ECU to a software version prior to updating by the update file, and perform updating again with a normal update file.

When receiving a new update file from the cloud server 100, the edge server 200 may guide the update of the ECU to the user terminal 400. In this connection, the edge server 200 may determine a guide scheme based on the service condition information (e.g., whether to notify the new update, the new update notification time, the update type, the update cycle, the update time, the update target, and the like) set by the user.

The edge server 200 may guide a location of an official A/S center to the user terminal 400 when inspection of an administrator is required in connection with the ECU update of the vehicle.

The edge server 200 may determine whether there is an ECU to be updated in the vehicle based on the update history information as the vehicle enters a short-range communication area, and notify a driver of the vehicle that there is no ECU to be updated. In this connection, the edge server 200 may notify that the ECUs of the vehicle are not an update target through an electronic board or through a loudspeaker, or notify the user terminal 400 that the ECUs of the vehicle are not the update target. When there is the ECU to be updated, the edge server 200 may update the ECU. When the update of the ECU is completed as such, the edge server 200 may update the update history information.

The vehicle terminal 300 may be implemented as a telematics terminal as an example, and may communicate with the edge server 200 through the short-range communication. That is, the vehicle terminal 300 may receive the update data of the ECU from the edge server 200 through the short-range communication.

The user terminal 400 may include a mobile phone, a tablet, a wearable device, and the like, and may communicate with the edge server 200 through the short-range communication. That is, the user terminal 400 may receive various notification information, guide information, and the like from the edge server 200 through the short-range communication. In addition, the user terminal 400 may access the cloud server 100 or the edge server 200 to set various conditions related to the ECU update.

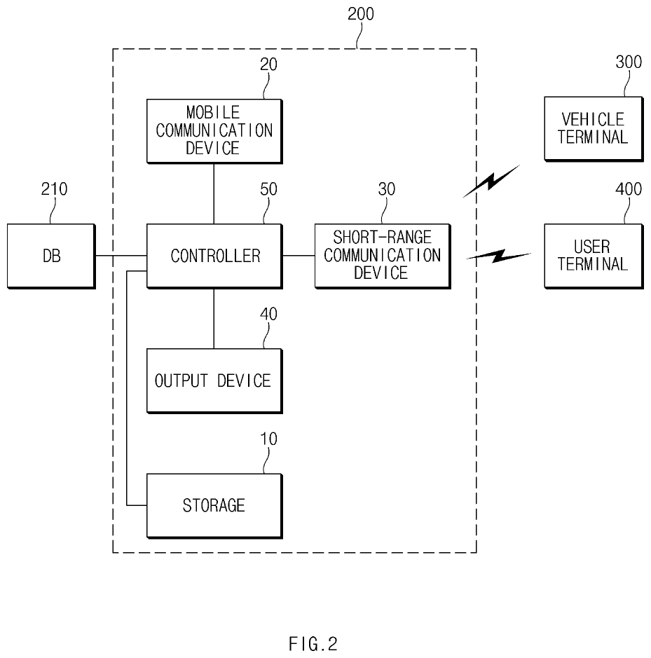

FIG. 2 is a block diagram of an ECU update management device of a vehicle according to an embodiment of the present disclosure.

As shown in FIG. 2, an ECU update management device 200 of a vehicle according to an embodiment of the present disclosure may include storage 10, a mobile communication device 20, a short-range communication device 30, an output device 40, and a controller 50. In particular, components may be combined with each other to be implemented as one component or some components may be omitted depending on a method for implementing the ECU update management device 200 of the vehicle according to an embodiment of the present disclosure.

Each of the components will be described. First, the storage 10 may store various logics, algorithms, and programs required in the process of transmitting the vehicle ECU (Electronic Control Unit) update guide message to the user terminal 400, transmitting the update file to the vehicle as the vehicle enters the short-range communication area, and managing the ECU update of the vehicle.

Such storage 10 may include at least one type of recording media (storage media) of a memory of a flash memory type, a hard disk type, a micro type, a card type (e.g., a secure digital card (SD card) or an eXtream digital card (XD card)), and the like, and a memory of a random access memory (RAM), a static RAM (SRAM), a read-only memory (ROM), a programmable ROM (PROM), an electrically erasable PROM (EEPROM), a magnetic RAM (MRAM), a magnetic disk, and an optical disk type.

The mobile communication device 20 may perform the long-distance communication with the vehicle terminal 300 and the user terminal 400.

The short-range communication device 30 may perform the short-range communication with the vehicle terminal 300 and the user terminal 400. In this connection, the short-range communication device 30 may perform the short-range communication in a scheme at least one of the Bluetooth™, the radio frequency identification (RFID), the infrared communication (infrared data association; IrDA), the ultra wideband (UWB), the ZigBee, the near field communication (NFC), the wireless universal serial bus (wireless USB), and/or the like.

The output device 40 may include a visual output device and an audible output device, the visual output device may include the electric board, and the auditory output device may include the loudspeaker.

The controller 50 may perform overall control such that each of the components may normally perform a function thereof. The controller 50 may be implemented in a form of hardware, software, or a combination of the hardware and the software. Preferably, the controller 50 may be implemented as a microprocessor, but may not be limited thereto.

In particular, the controller 50 may perform various control in the process of transmitting the vehicle ECU (Electronic Control Unit) update guide message to the user terminal 400, transmitting the update file of the ECU to the vehicle as the vehicle enters the short-range communication area, and managing the ECU update of the vehicle. In this connection, the controller 50 may adjust a transmission period and a transmission time of the guide message based on the conditions preset by the user.

The controller 50 may manage the update history information in which the updated ECU, the update date, the update time, and the update version are recorded for each user. That is, the controller 50 may manage the update history information in which at least one of the updated ECU, the update date, the update time, and/or the update version is recorded for each user.

When there is no update target ECU in the vehicle that has entered the short-range communication area, the controller 50 may notify the user terminal that there is no ECU to be updated. In this connection, the controller 50 may transmit a notification message through the mobile communication device 20 or may transmit the notification message through the short-range communication device 30.

The controller 50 may detect the transmission error (the packet loss and the like) in the process of receiving the update file of each ECU for each vehicle model from the cloud server 100.

When the error occurs in the process of updating the ECU of the vehicle, the controller 50 may perform the roll back of returning the software version of the ECU to the software version prior to the update. That is, the controller 50 may control the ECU to perform the roll back. In this connection, the controller 50 may notify the user terminal 400 of the error in the update file through the mobile communication device 20 or the short-range communication device 30.

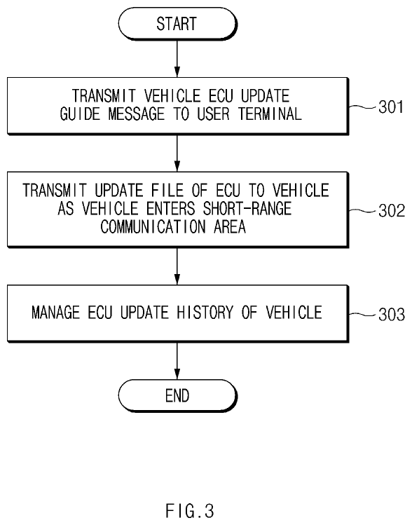

FIG. 3 is a flowchart of a method for updating an ECU of a vehicle according to an embodiment of the present disclosure.

First, the mobile communication device 20 transmits the vehicle ECU (Electronic Control Unit) update guide message to the user terminal (301).

Thereafter, the short-range communication device 30 transmits the update file to the vehicle as the vehicle enters the short-range communication area (302).

Thereafter, the controller 50 manages an ECU update history of the vehicle (303). In this connection, the controller 50 may manage not only the ECU update history of the vehicle, but also the ECU update data, ECU update monitoring, and the like.

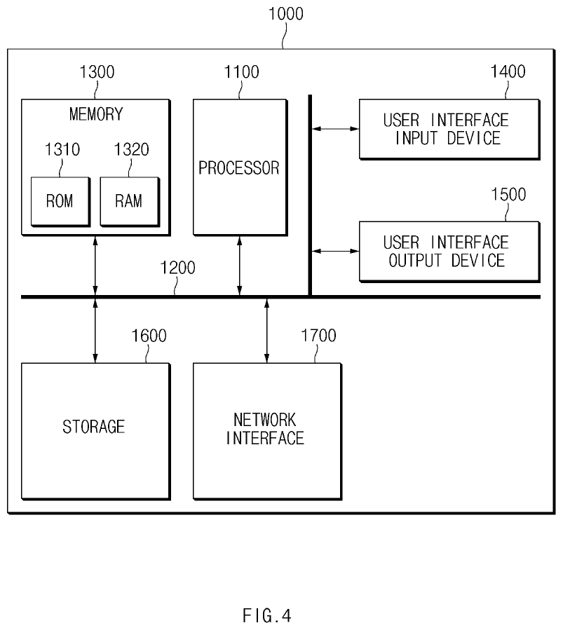

FIG. 4 is a block diagram showing a computing system for executing a method for updating an ECU of a vehicle according to an embodiment of the present disclosure.

With reference to FIG. 4, the method for updating the ECU of the vehicle according to an embodiment of the present disclosure described above may also be implemented with a computing system. A computing system 1000 may include at least one processor 1100, a memory 1300, a user interface input device 1400, a user interface output device 1500, storage 1600, and a network interface 1700 connected via a system bus 1200.

The processor 1100 may be a central processing unit (CPU) or a semiconductor device that performs processing on commands stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Thus, the operations of the method or the algorithm described in connection with the embodiments disclosed herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a solid state drive (SSD), a removable disk, and a CD-ROM. The exemplary storage medium is coupled to the processor 1100, which may read information from, and write information to, the storage medium. In another method, the storage medium may be integral with the processor 1100. The processor and the storage medium may reside within an application specific integrated circuit (ASIC). The ASIC may reside within the user terminal. In another method, the processor and the storage medium may reside as individual components in the user terminal.

The description above is merely illustrative of the technical idea of the present disclosure, and various modifications and changes may be made by those skilled in the art without departing from the essential characteristics of the present disclosure.

Therefore, the embodiments disclosed in the present disclosure are not intended to limit the technical idea of the present disclosure but to illustrate the present disclosure, and the scope of the technical idea of the present disclosure is not limited by the embodiments. The scope of the present disclosure should be construed as being covered by the scope of the appended claims, and all technical ideas falling within the scope of the claims should be construed as being included in the scope of the present disclosure.

The system and the method for managing updating of the ECU of the vehicle according to an embodiment of the present disclosure as described above have the cloud server that manages updating of each electronic control unit (ECU) in the vehicle, and the edge server located in the predetermined zone and in communication with the cloud server, and the edge server transmits the update data of the ECU to the vehicle in the short-range communication scheme, thereby providing the ECU update service to the vehicle to which the over the air (OTA) technology is not applied regardless of the time.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A device for managing an update of an electronic control unit (ECU) of a vehicle, the device comprising:
a first communication device configured to transmit a vehicle ECU update guide message to a user terminal;
a second communication device configured to transmit an update file to the vehicle as the vehicle enters a short-range communication area; and
a controller configured to manage updating of the ECU of the vehicle.

2. The device of claim 1, wherein the controller is configured to manage update history information, wherein at least one of an updated ECU, an update date, an update time, or an update version is recorded in the update history information.

3. The device of claim 1, wherein the controller is configured to notify that there is no ECU to be updated to the user terminal when there is no ECU to be updated in the vehicle that has entered the short-range communication area.

4. The device of claim 1, further comprising:
a DB for storing an update file of each ECU for each vehicle model received from a cloud server.

5. The device of claim 4, wherein the controller is configured to detect an error in a process of receiving the update file of each ECU for each vehicle model.

6. The device of claim 1, wherein the controller is configured to perform a roll back of returning a software version of the ECU to a software version prior to the update when an error occurs in the process of updating the ECU of the vehicle.

7. The device of claim 6, wherein the controller is configured to notify that there is an error in the update file to the user terminal.

8. The device of claim 1, wherein the controller is configured to adjust at least one of a transmission period or a transmission time of the guide message based on preset conditions.

9. A method for managing an update of an electronic control unit (ECU) of a vehicle, the method comprising:
transmitting, by a first communication device, a vehicle ECU update guide message to a user terminal;
transmitting, by a second communication device, an update file to the vehicle as the vehicle enters a short-range communication area; and
managing, by a controller, updating of the ECU of the vehicle.

10. The method of claim 9, wherein managing updating of the ECU of the vehicle includes:
managing update history information, wherein at least one of an updated ECU, an update date, an update time, or an update version is recorded in the update history information.

11. The method of claim 9, wherein transmitting the update file further includes:
notifying that there is no ECU to be updated to the user terminal when there is no ECU to be updated in the vehicle that has entered the short-range communication area.

12. The method of claim 9, wherein managing updating of the ECU of the vehicle includes:
performing a roll back of returning a software version of the ECU to a software version prior to the update when an error occurs in the process of updating the ECU of the vehicle.

13. The method of claim 12, wherein managing updating of the ECU of the vehicle further includes:
notifying that there is an error in the update file to the user terminal.

14. The method of claim 9, wherein transmitting the update file further includes:
adjusting at least one of a transmission period or a transmission time of the guide message based on preset conditions.
